(19) United States
(12) Patent Application Publication
(10) Pub. No.: US 2010/0319004 A1
(43) Pub. Date: Dec. 16, 2010

(54) Policy Management for the Cloud

(75) Inventors: William Hunter Hudson, Kirkland, WA (US); Patrick J. Helland, Seattle, WA (US); Benjamin G. Zorn, Woodinville, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,678

(22) Filed: Jun. 16, 2009

(51) Int. Cl. G06F 9/54; G06F 9/46

(52) U.S. Cl. 719/313; 719/328

(57) ABSTRACT

An exemplary policy management layer includes a policy module for a web-based service where the policy module includes logic to make a policy-based decision and an application programming interface (API) associated with an execution engine associated with resources for providing the web-based service, where the API is configured to communicate information from the execution engine to the policy module and where the API is configured to receive a policy-based decision from the policy module and to communicate the policy-based decision to the execution engine to thereby effectuate policy for the web-based service. Various other devices, systems, methods, etc., are also described.

### BACKGROUND

Large scale datacenters are a relatively new human artifact, and their organization and structure has evolved rapidly as the commercial opportunities they provide has expanded. Typical modern datacenters are organized collections of clusters of hardware running collections of standard software packages, such as web servers database servers, etc. interconnected by high speed networking, routers, and firewalls. The task of organizing these machines, optimizing their configuration, debugging errors in their configuration, and installing and uninstalling software on the constituent machines is largely left to human operators.

Moreover, because the Web services these datacenters are supporting are also rapidly evolving (for example, a company might first offer a search service, and then an email service, and then a map service, etc.) the structure and organization of the datacenter logistics, especially as to agreements (e.g., service level agreements) might need to be changed accordingly. Specifically, negotiation of service level agreements can be an expensive and time consuming process for both a service provider and a datacenter operator or owner. Traditional service level agreements tend to be quite limited and not always express metrics that a service provider would like to see or metrics that may be beneficial to optimize operation of a datacenter.

Various exemplary technologies described herein pertain to policy management. Exemplary mechanisms allow for use of policies that can form new, flexible and extensible types of “agreements” between service providers and resource managers or owners. In turn, risk and reward can be sliced and more readily assigned or shifted between service providers, end users and resource managers or owners.

### SUMMARY

An exemplary policy management layer includes a policy module for a web-based service where the policy module includes logic to make a policy-based decision and an application programming interface (API) associated with an execution engine associated with resources for providing the web-based service, where the API is configured to communicate information from the execution engine to the policy module and where the API is configured to receive a policy-based decision from the policy module and to communicate the policy-based decision to the execution engine to thereby effectuate policy for the web-based service. Various other devices, systems, methods, etc., are also described.

### DESCRIPTION OF DRAWINGS

Non-limiting and non-exhaustive examples are described with reference to the following figures:

FIG. 1 is a block diagram of a conventional service level agreement (SLA) environment;

FIG. 2 is a block diagram of an exemplary service level agreement (SLA) environment that includes mechanisms related to policy;

FIG. 3 is a block diagram of an exemplary method for making policy decisions as to location of data;

FIG. 4 is a block diagram of an exemplary environment where each of multiple service providers provides code where dependencies exist between the provided code;

FIG. 5 is a block diagram of an exemplary scheme for making policy decisions related to geographical location of data or computations;

FIG. 6 is a block diagram of an exemplary scheme where various parties can provide or use policy modules;

FIG. 7 is a block diagram of an exemplary method where a prior failure or degradation in service for a user causes a policy module to make a policy decision to ensure that the user receives adequate service;

FIG. 8 is a block diagram of an exemplary scheme for service level agreements (SLAs);

FIG. 9 is a block diagram of an exemplary method for selecting an SLA based in part on code testing; and

FIG. 10 is a block diagram of an exemplary computing device.

### DETAILED DESCRIPTION

As mentioned in the Background section, various issues exist in conventional computational environments that make agreement as to level of services and management of agreed upon services, whether in a datacenter or cloud, somewhat difficult, inflexible or time consuming. For example, conventional service level agreements (SLAs) articulate relatively simple rules/constraints that do not adequately or accurately reflect how service providers and end users rely on cloud resources. As described herein, various exemplary technologies support more complex rules/constraints and can more readily model particular service provider and end user scenarios. Further, various schemes allow for automatic generation of SLAs and facilitate entry into binding agreements.

As described herein, resources may be under the control of a data center host, a cloud manager or other entity. Where a controlling entity offers resources to others, some type of agreement is normally reached as to, for example, performance and availability of the resources (e.g., a service level agreement).

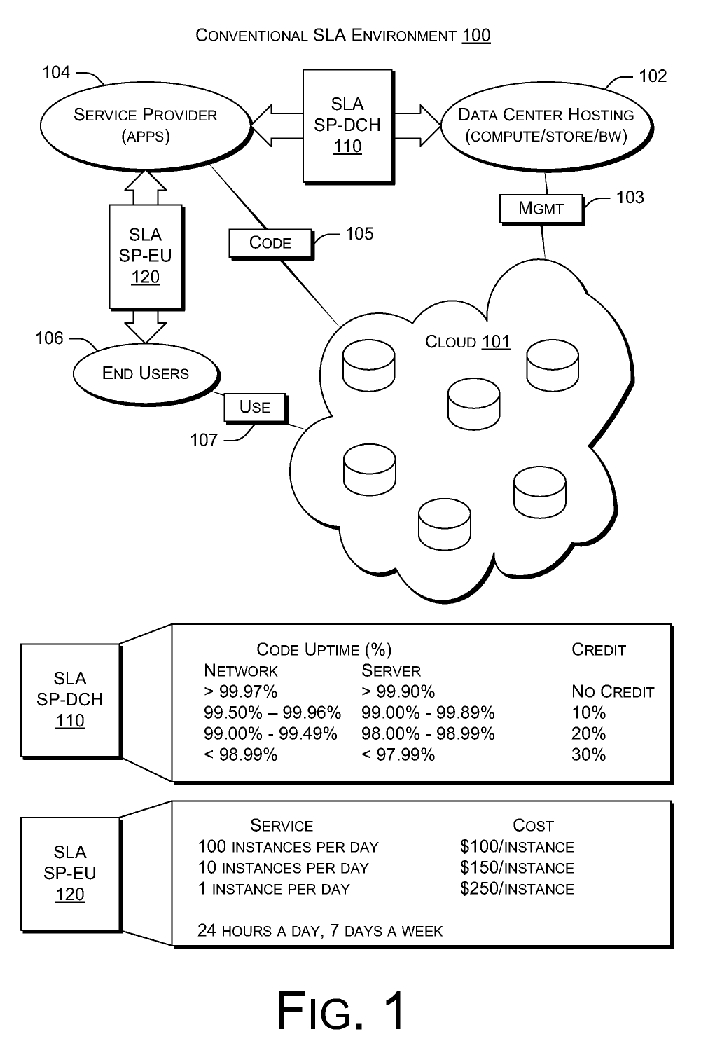

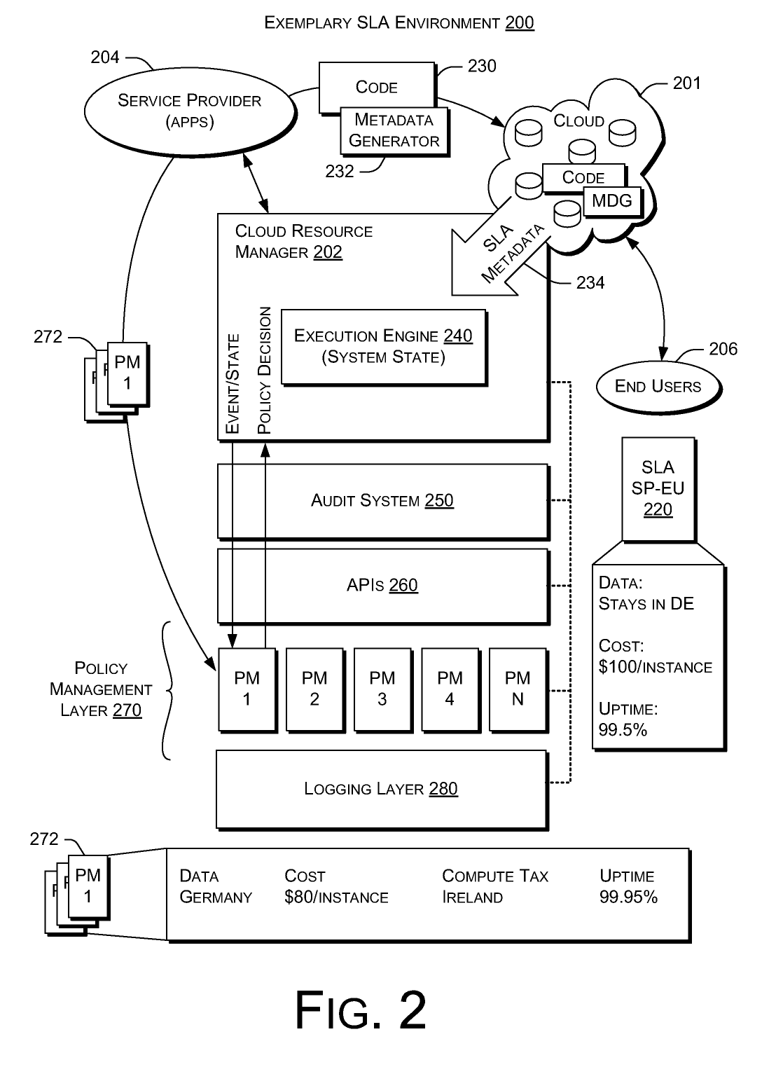

FIG. 1, which is described in more detail below, shows a data center or resource hosting service as a controlling entity. In various other examples, a cloud manager (see, e.g., FIGS. 2, 4, 6 and 8) is shown as a controlling entity. Various exemplary techniques described herein can be applied to any of a variety of controlling entities where resources may be any type or types of resources along a spectrum from specific resources to data center resources to cloud resources. For example, specific resources may be a fiber network with communication hardware, data center resources may be all resources available within the confines of a data center (e.g., hardware, software, etc.), and cloud resources may be various resources considered as being within “the cloud”.

Various commercially available controlling entities exist. For example, the AZURE® Services Platform (Microsoft Corporation, Redmond, Wash.) is an internet-scale cloud services platform hosted in data centers operated by Microsoft Corporation. The AZURE® Services Platform lets developers provide their own unique customer offerings via a broad offering of foundational components of compute, storage, and building block services to author and compose applications in the cloud (e.g., may optionally include a software development kit (SDK)). Hence, a developer may develop a service (e.g., using a SDK or other tools) and act as a service provider by simply having the service hosted by the AZURE® Services Platform per an agreement with Microsoft Corporation.

The AZURE® Services Platform provides an operating system (WINDOWS® AZURE®) and a set of developer services (e.g., .NET® services, SQL® services, etc.). The AZURE® Services Platform is a flexible and interoperable platform that can be used to build new applications to run from the cloud or enhance existing applications with cloud-based capabilities. The AZURE® Services Platform has an open architecture that gives developers the choice to build web applications, applications running on connected devices, PCs, servers, hybrid solutions offering online and on-premises resources, etc.

The AZURE® Services Platform can simplify maintaining and operating applications by providing on-demand compute and storage to host, scale, and manage web and connected applications (e.g., services that a service provider may offer to various end users). The AZURE® Services Platform has automated infrastructure management that is designed for high availability and dynamic scaling to match usage needs with an option of a pay-as-you-go pricing model. As described herein, various exemplary techniques may be optionally implemented in conjunction with the AZURE® Services Platform. For example, an exemplary policy management layer may operate in conjunction with the infrastructure management techniques of the AZURE® Services Platform to generate, enforce, etc., policies or SLAs between a service provider (SP) and Microsoft Corporation as a host. In turn, the service provider (SP) may enter into agreements with its end users (e.g., SP-EU SLAs).

A conventional service provider and data center hosting service SLA is referred to herein as a SP-DCH SLA. However, as explained above, where a cloud services platform is relied upon, the terminology “SP-DCH SLA” can be too restrictive as the exemplary policy management layer creates an environment that is more dynamic and flexible. In various examples, there is no “set-in-stone” SLA but rather an ability to generate, select and implement policies “ala cart” or “on-the-fly”. Thus, the policy management layer creates a policy framework where parties may enter into a conventional “set-in-stone” SP-DCH SLA or additionally or alternatively take advantage of many other types of agreement options, whether static or dynamic.

As described in more detail below, an exemplary policy management layer may allow policies to be much more expressive and complex than existing SLAs; allow for addition of new policies (e.g., related to new business practices and models); allow for innovation in new policies (e.g., by providing a platform on which innovation in the underlying services can occur); and/or allow a service provider to actively contribute to the definition, implementation, auditing, and enforcement of policies.

While the AZURE® Services Platform is mentioned as a controlling entity, other types of controlling entities may implement or operate in conjunction with various exemplary techniques described herein. For example, “Elastic Compute Cloud” services also known as EC2® services (Amazon, Corporation, Seattle, Wash.) and Force.com® services (Salesforce.com, Inc., San Francisco, Calif.) may be controlling entities for resources, whether in a single data center, multiple data centers or, more generally, within the cloud.

An exemplary approach aims to separate the SLA from the code, which can, in turn, enable some more complex SLA use cases (e.g., scenarios). Such an approach can use so-called policy modules that can declaratively (e.g., by use of a simple rule or complex logic) specify data/computation significance (e.g., policies as to data, privacy, durability, ease of replication, etc.); specify multiple roles (e.g., developer, business, operations, end users); specify multiple content (e.g., energy consumption, geopolitical, tax); or specify time (JIT vs. recompile vs. runtime).

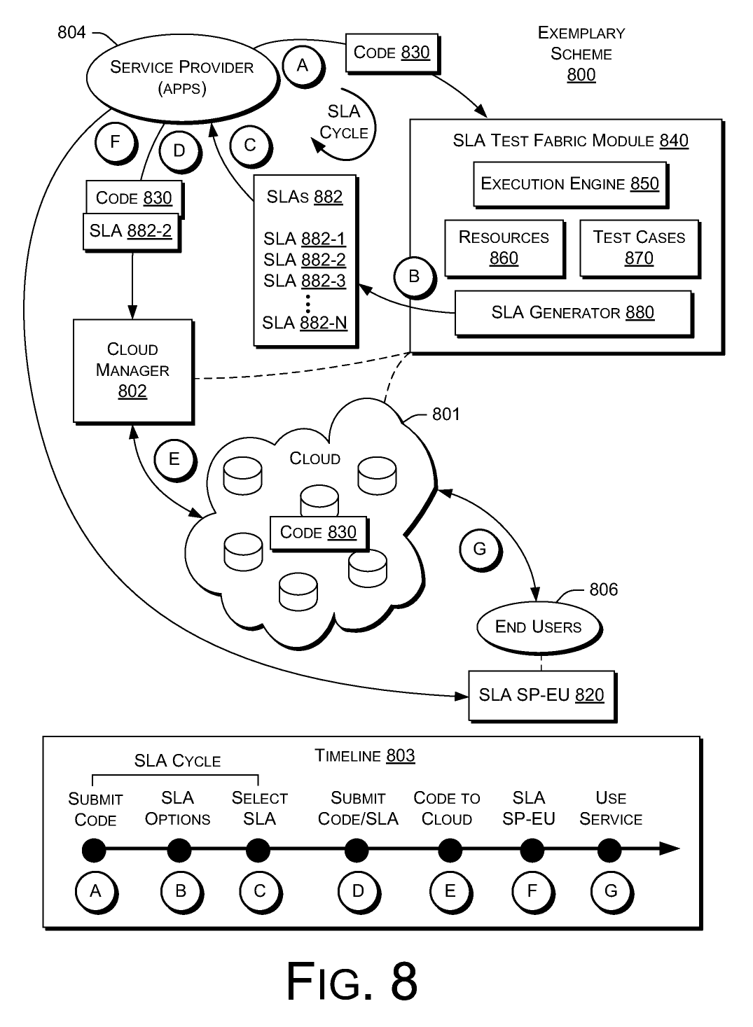

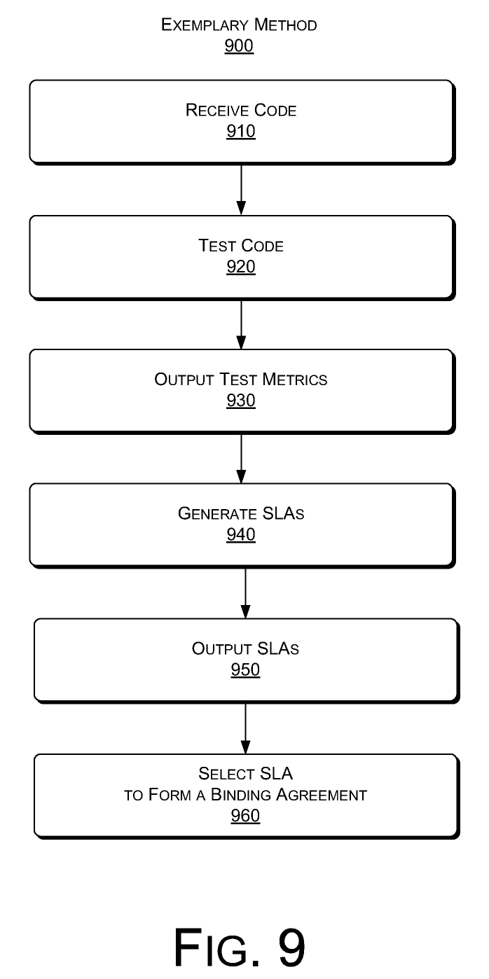

Various exemplary approaches may rely on code, for example, to generate metadata or test metrics for use in generating or managing SLAs or underlying policies. Some examples that include use of code for outputting test metrics are described with respect to FIGS. 8 and 9.

An exemplary policy module may include logic for making policy decisions that target particular businesses or particular users; that give stronger support for articulating/enforcing energy policies; or that provide support for measuring OpEx (operational expenses) and RevStream (revenue streams) as part of an overall SLA directive. A policy module may effectuate a “screw-up” policy that accounts for failures or degradation in service. A policy module can include logic that can trade price for performance as explicitly stated in a corresponding SLA or include logic that aims to gather evidence or implement policies to find out what customers are willing to pay for reliability, latency, etc. A policy module may act to tolerate some failure while acting to minimize multiple failures to the same user or at same location or for a particular type of transaction.

FIG. 1 shows a conventional service level agreement (SLA) environment 100. The environment 100 includes a cloud 101 of computing and related resources, a data center or resource hosting service (DCH) 102 that operates via a management component(s) 103 to manage resources in the cloud 101, a service provider (SP) 104 that relies on resources in the cloud 101 to execute code 105 and end users (EU) that communicate data or instructions to use 107 the code 105 as executed in the cloud 101.

In the example of FIG. 1, the conventional SLA environment 100 includes two SLAs: an SLA 110 between the service provider 104 and the data center hosting service 102 (SLA SP-DCH) and an SLA 120 between the service provider 104 and the end users 106 (SLA SP-EU).

The conventional SLA SP-DCH 110 typically specifies a relationship between a basic performance metric (e.g., percentage of code uptime) and cost (e.g., credit). As shown, as the basic performance metric decreases, the service provider 104 receives increasing credit. For example, if the cost for network uptime greater than 99.97% and server uptime greater than 99.90% is $100 per day, a decrease in performance of network uptime to 99.96% or a decrease in server uptime to 99.89% results in a credit of $10 per day. Thus, as performance of one or more of the basic metrics decreases, the service provider 104 pays the data center hosting service at a reduced rate or, where pre-payment occurs, the service provider 104 receives credit for diminished performance. As indicated in FIG. 1, the nature of this relationship is set forth in a legally binding contract known as the service level agreement (SLA SP-DCH 110).

The conventional SLA SP-EU 120 typically specifies a relationship between a basic usage metric (e.g., instances of use per day) and cost (e.g., cost per instance). As shown, as instance usage increases, the end user 106 receives a lesser cost per instance of usage. For example, if the end user 106 uses the service of the service provider 104 once per day, the cost is $250 for the one instance. As the end user 106 uses the service more frequently, the cost decreases where for 100 instances of usage per day cost only $100 per instance. In the example of FIG. 1, the SLA SP-EU 120 further provides for access 24 hours a day and 7 days a week. As discussed for the SLA SP-DCH 110, the end user 106 may receive credit or a discount when availability is less than 24 hours a day and 7 days a week. As indicated in FIG. 1, the nature of the relationship between the service provider 104 and the end user 106 is set forth in a legally binding contract known as the service level agreement (SLA SP-EU 120).

FIG. 2 shows an exemplary SLA environment 200 that includes mechanisms for a service provider 204 to specify desired requirements for a service level agreement with a cloud resource manager 202, which may also perform tasks performed by the data center hosting service 102 of the conventional environment 100 of FIG. 1. As explained, the cloud resource manager 202 may be a controlling entity such as the AZURE® Services Platform or other platform. The SLA environment 200 also includes a cloud 201, end users 206, an SLA SP-EU 220, code 230 that optionally includes a metadata generator 232 to generate SLA metadata 234, an execution engine 240, an audit system 250, application programming interfaces (APIs) 260, a policy management layer 270 configured to receive policy management information 272 and a logging layer 280. As indicated by a dashed line, the cloud resource manager 202 may control or otherwise communicate with the audit system 250, the APIs 260, the policy management layer 270 and/or the logging layer 280. Further, one or more of the audit system 250, the APIs 260, the policy management layer 270 and the logging layer 280 may be part of the cloud resource manager 202.

As described herein, the cloud resource manager 202 may have one or more mechanisms that contribute to decisions about whether a policy is agreeable, not agreeable or agreeable with some modification(s). For example, one mechanism may require that all policy modules of the policy module layer 270 are pre-approved (e.g., certified). Such an approval or vetting process may include testing possible scenarios and optionally setting bounds where a policy module cannot call for a policy outside of the bounds. Another mechanism may require that all policy modules be written to comply with a specification where the specification sets guidelines as to policy scope (e.g., with respect to latency, storage location, etc.). Yet another mechanism may be dynamic where a policy module is examined or tested upon plug-in. By one or more of these mechanisms, the cloud resource manager 202 may contribute to decisions as to whether a policy is agreeable, not agreeable or agreeable with some modification(s). Such mechanisms may be implemented whether or not the policy management layer 270 is part of or under direct control by the cloud resource manager 202.

The mechanisms for the service provider 204 to specify desired requirements for a service level agreement with the cloud resource manager 202 include (i) the metadata generator 232 to generate SLA metadata 234 and (ii) the policy management layer 270 that consumes and responds to policy management information 272 via the APIs 260.

With respect to the metadata generator 232, this may be a set of instructions, parameters or a combination of instructions and parameters that accompanies or is associated with the code 230. For example, the metadata generator 232 may include information (e.g., instructions, parameters, etc.) suitable for consumption by a cloud services operating system that serves as a development, service hosting, and service management environment for cloud resources. A particular example of such an operating system is the WINDOWS® AZURE® operating system (Microsoft Corporation, Redmond, Wash.), which provides on-demand compute and storage to host, scale, and manage Web applications and services in one or more data centers.

In an example where the AZURE® Services Platform is used as a cloud resource manager 202, a hosted application for a service may consist of instances where each instance runs on its own virtual machine (VM). In the AZURE® Services Platform, each VM contains a WINDOWS® AZURE® agent that allows a hosted application to interact with the WINDOWS® AZURE® fabric. The agent exposes a WINDOWS® AZURE®-defined API that lets the instance write to a WINDOWS® AZURE®-maintained log, send alerts to its owner via the WINDOWS® AZURE® fabric, and other tasks.

In the foregoing AZURE® Services Platform example, the so-called WINDOWS® AZURE® fabric controller may be used. This fabric controller manages resources, load balancing, and the service lifecycle of an application, for example, based on requirements established by a developer. The fabric controller is configured to deploy an application (e.g., a service) and manage upgrades and failures to maintain its availability. As such, the fabric controller can monitor software and hardware activity and adapt dynamically to any changes or failures. The fabric controller controls resources and manages them as a shared pool for hosted applications (e.g., services). The AZURE® fabric controller may be a distributed controller with redundancy to support uptime and variations in load, etc. Such a controller may be implemented as a virtualized controller (e.g., via multiple virtual machines), a real controller or as a combination of real and virtualized controllers. As described herein such a fabric controller may be a component configured to “own” cloud resources and manage placement, provisioning, updating, patching, capacity, load balancing, and scaling out of cloud nodes using the owned cloud resources.

In a particular example, the metadata generator 232 references the code 230 and generates metadata 234 during execution of the code 230 in the cloud 201. For example, the metadata generator 232 may generate metadata 234 that notifies the execution engine 240 that the code 230 includes policies, which may be associated with the policy management layer 270. In the foregoing example for the AZURE® Services Platform, the metadata generator 232 may be a VM that generates metadata 234 and invokes its agent to communicate the metadata to the WINDOWS® AZURE® fabric. Further, such a VM may be the same VM for an instance (i.e., a VM that executes the code 230 and generates metadata 234 based on information contained within the code 230).

In a specific example, the metadata generator 232 generates metadata 234 that indicates that data generated by execution of the code 230 is to be stored in Germany or more generally that the storage location of data generated by execution of the code 230 is a parameter that is part of a service level agreement (e.g., a policy requirement) between the service provider 204 and the cloud resource manager 202 (and/or possibly the SLA SP-EU 220). Accordingly, in this example, the execution engine 240 is instructed to emit state information about the location of data generated by execution of the code 230 and make this information available to manage or enforce the associated location policy. Further, the execution engine 240 may emit state information as to actions such as “replicate data”, “move data”, etc. Such emitted state information is represented as an “event/state” arrow that can be communicated to the audit system 250 and the APIs 260.

With respect to the AZURE® Services Platform, to a service provider, hosting of a service appears as stateless. By being stateless, the AZURE® Services Platform can perform load balancing more effectively, which means that no guarantees exist that multiple requests for a hosted service will be sent to the same instance of that hosted service (e.g., assuming multiple instances of the service exist). However, to the AZURE® Services Platform as a controlling entity, state information exists for the managed resources (e.g., server, hypervisor, virtual machine, etc.). For example, the AZURE® Services Platform fabric controller includes a state machine that maintains internal data structures for logical services, logical roles, logical role instances, logical nodes, physical nodes, etc. In operation, the AZURE® fabric controller provisions based on a maintained state machine for each node where it can move a node to a new state based on various events. The AZURE® fabric controller also maintains a cache about the state it believes each node to be in where a state is reconciled with true node state via communication with agent and allows a goal state to be derived based on assigned role instances. On a so-called “heartbeat event” the AZURE® fabric controller tries to move a node closer to its goal state (e.g., if it is not already there). The AZURE® fabric controller can also track a node to determine when a goal state is reached.

Referring again to the example of FIG. 2, the execution engine 240 may be considered to include system state information that allows for effective management of resources. As described in more detail below, state information allows for effective management in a manner that can help ensure that a controlling entity (e.g., the cloud resource manager 202) can implement policies or know when a policy or policies will be compromised. The execution engine 240 may be or include features of the aforementioned fabric controller of the AZURE® Services Platform. Hence, a VM may generate metadata 234 and emit the metadata 234 via its agent for receipt by a fabric controller (e.g., via exposure of a WINDOW® AZURE®-defined API or other suitable technique).

As mentioned, the second mechanism of the exemplary SLA system 200 involves the policy management layer 270 that consumes and responds to policy management information 272 via the APIs 260. For example, the service provider 204 may issue policy management information 272 in the form of a policy module that plugs into one or more of the APIs 260. As described herein, a one-to-one correspondence may exist between a policy module and an API. For example, the APIs 260 may include a data location API that responds to calls with one or more parameters such as: data action, data location, data age, number of data copies and data size.

Accordingly, referring again to the example where data generated by the code 230 must reside in Germany, once the service provider 204 issues the policy management information 272, the policy management layer 270 may receive event and/or state information for the data (e.g., as instructed by the generated metadata 234) and feed this information to a policy module (e.g., PM 1). In turn, the policy module compares the event and/or state information to a policy, i.e., “The data must reside in Germany”. If the policy module decides that the event and/or state information violates this policy, then the policy module communicates a policy decision via the appropriate API, which is forwarded to the execution engine 240 to prohibit, for example, replication of the data in a data center in Sweden. In this example, the execution engine 240 can select an alternative state, i.e., to avoid replication of the data in a data center in Sweden.

In another example, the metadata generator 232 generates metadata 234 that pertains to cost and the service provider 204 issues policy information 272 in the form of a policy module (e.g., PM 2) to receive and respond to events and/or states pertaining to cost. For example, if the execution engine 240 emits state information indicating that cost will exceed $80 per instance of the code 230 being executed, upon receipt of the state information, the policy module PM 2 will respond by emitting an instruction that instructs the execution engine 240 to prohibit the state from occurring because it will violate a policy (e.g., of a service level agreement).

In another example, the metadata generator 232 generates metadata 234 that pertains to location of computation (e.g., due to tax concerns). In this example, the metadata 234 may refer to specific computation intensive tasks such as search, which may not necessarily generate the ultimate data the end users 206 receive. In other words, the code 230 may include search as an intermediate step that is computationally intensive and the service provider 204 may permit transmission of search results across national or regional political boundaries without violating a desired policy. To enforce the compute location policy, the service provider 204 issues policy information 272 in the form of a policy module (e.g., PM 3) to the policy management layer 270 that interacts with the execution engine 240 via an appropriate one of the APIs 260. In this example, the execution engine 240 emits event and/or state information for the location of compute for specific computational tasks of the code 230. The policy module PM 3 can consume the emitted information and respond to instruct the execution engine 240 to ensure compliance with a policy. Consider emitted state information that indicates, compute unavailable in Ireland for time period 12:01 GMT to 12:03 GMT and compute will be performed in England. The policy module may consume this state information and compare it to a taxation policy: “Prohibit compute in England” (e.g., profits generated based on compute in England). Hence, the policy module will respond by issuing an instruction that prohibits the execution engine 240 from changing the execution state to compute in England. In this instance, the service provider 204 may readily accept the consequences of a 2 minute downtime for the particular compute functionality. Alternatively, the policy module PM 3 may instruct the execution engine 240 to perform compute in another location (e.g., Germany, as it is proximate to at least some of the data). Further, the policy module PM 3 may include dynamic policies that dictate policies that vary by time of day or in response to other conditions. In general, a policy module may be considered as a statement of business rules. An exemplary policy module may express policy in the form of a mark-up language (e.g., XML, etc.).

In another example, the metadata generator 232 emits metadata 234 that instructs the execution engine 240 to emit events and/or state information related to uptime. This information may be consumed by a policy module (e.g., PM 4) issued by the service provider 204. The policy module PM 4 may simply store or report uptime to the cloud resource manager 202, the service provider 204 or both the cloud resource manager 202 and the service provider 204. Such a reporting system may allow for crediting an account or other alteration in cost.

Given the foregoing mechanisms, the service provider 204 can form an appropriate SLA with its end users 206 (i.e., the SLA SP-EU 220). For example, if the end users 206 require that data reside in Germany (e.g., due to banking or other national regulations), the service provider 204 can provide for a policy using the metadata generator 232 and the policy management layer 270. Further, the service provider 204 can manage costs and profit via the metadata generator 232 and the policy management layer 270. Similarly, uptime provisions may be included in the SLA SP-EU 220 and managed via the metadata generator and the policy management layer 270.

While various examples explained with respect to the environment 200 of FIG. 2 refer to the metadata generator to generate metadata 234, in an alternative arrangement, the execution engine 240 may be programmed to emit particular event and/or state information automatically, i.e., without instruction from the metadata generator 232. In such an alternative arrangement, the metadata generator 232 is not necessarily required. In either instance, the policy management layer 270 allows for consuming relevant event and/or state information and responding to such information with policy decisions that affect how the execution engine 240 executes code, stores data, etc.

As described herein, an exemplary scheme allows a service provider to select a level of service (e.g., bronze, silver, gold and platinum). Such preset levels of service may be part of a service level agreement (SLA) that can be monitored or enforced via the exemplary policy management layer 270 and optionally the metadata generator 232 mechanism of FIG. 2. For example, the APIs 260 may include a bronze API, a silver API, a gold API and a platinum API where the service provider 204 issues corresponding policy information 272 in the form of a policy module (e.g., a bronze, silver, gold or platinum) to interact with the appropriate service level API. In such a scheme, the amount of event and/or state information may be richer as the level of service increases. For example, if a service provider 204 requires only a “bronze” level of service, then only a few types of event and/or state information may be available at a bronze level API; whereas, for a “platinum” level of service, many types of event and/or state information may be available at the platinum API, which, in turn, allow for more policies and, in general, a more comprehensive service level agreement between the service provider 204 and the cloud resource manager 202. This scheme presents the service provider 204 with various options to include or leverage when forming end user service level agreements (e.g., consider the SLA SP-EU 220).

As described herein, the service provider 204 can provide code 230 that specifies a level of service from a hierarchical level of services. In turn, the cloud resource manager 202 can manage execution of the code 230 and associated resources of the cloud 201 more effectively. For example, if resources become congested or off-line, the cloud resource manager 202 may make decisions based on the specified levels of service for each of a plurality of codes submitted by one or more service providers. Where congestion occurs (e.g., network bandwidth congestion), the cloud resource manager 202 may halt execution of code with the bronze level of service, which should help to maintain or enhance execution of code with a higher level of service.

The execution engine 240 may consume the metadata 234 and manage resources of the cloud 201 based on policy decisions received from a policy management layer 270 (e.g., via the APIs 260). As event and state information is communicated to the audit system 250, analyses may be performed to understand better communicated event and state information and policy decisions in response to the communicated event and state information. The logging layer 280 is configured to log policy information 272, for example, as received in the form of policy modules.

In the example of FIG. 2, the end users 206 optionally emit complaint information to the cloud 201, which may be enabled via the code 230 and the metadata generator 232. In such an approach, the execution engine 240 may emit event and state information as to complaints themselves and possibly event and state information germane to when complaints are received. In this example, the APIs 260 may include a complaint API configured to communicate with a policy module (e.g., PM N). The realm of complaints and possible solutions may be programmed within logic of the policy module PM N such that the policy module PM N issues policy decisions that can instruct the execution engine 240 in a manner to address the complaints. For example, if complaints are received by high value customers due to limited resources, the policy module PM N may instruct the execution engine 240 to pull resources away from less valuable customers.

With respect to auditing, the audit system 250 can capture policy decisions emitted by the policy module, for example, as part of a communication pathway from the APIs 260. Thus, when the service provider 204 plugs-in a policy module (e.g., PM 1), decisions emitted by the policy module are captured by the audit system 250 for audits or forensics, for example, to understand better why or why not a policy may have been violated. As mentioned, the audit system 250 can also capture event and/or state information. The audit system 250 may capture event and/or state information along with identifiers or it may assign identifiers to the event and/or state information which are carried along to the APIs 260 or the policy module of the policy management layer 270. In turn, once a policy decision is emitted by a policy module, the policy decision may carry an assigned identifier such that a match process can occur in the audit system 250 or one or more of the APIs 260 may assign a received identifier to an emitted policy decision. In either of these examples, the audit system 250 can link event and/or state information emitted by the execution engine 240 and associated policy decisions of the policy management layer 270.

In the exemplary environment 200, an audit may occur as to failure to meet a level of service. The audit system 250 may perform such an audit and optionally interrogate relevant policy modules to determine whether the failure stemmed from a policy decision or, alternatively, by fault of the cloud manager 202 of resources in the cloud 201. For example, a policy module may include logic that does not account for all possible events and/or states. In this example, the burden of proper policy module logic and hence performance may lie with the service provider 204, the cloud manager 202, a provider of policy modules, etc. Accordingly, risk may be distributed or assigned to parties other than the service provider 204 and the cloud resource manager 202.

As described herein, the environment 200 can allow for third-party developers of policy. For example, an expert in international taxation of electronic transactions may develop tax policies for use by service providers or others (e.g., according to a purchase or license fee). A tax policy module may be available on a subscription or use basis. A tax expert may provide updates in response to more beneficial tax policies or changes in tax law or changes in other circumstances. According to such a scheme, a service provider may or may not be required to include a metadata generator 232 in its code, for example, depending on the nature of event and/or state information emitted by the execution engine 240. Hence, a service provider may be able to implement policies merely by licensing one or more appropriate policy modules (e.g., an ala cart policy selection scheme).

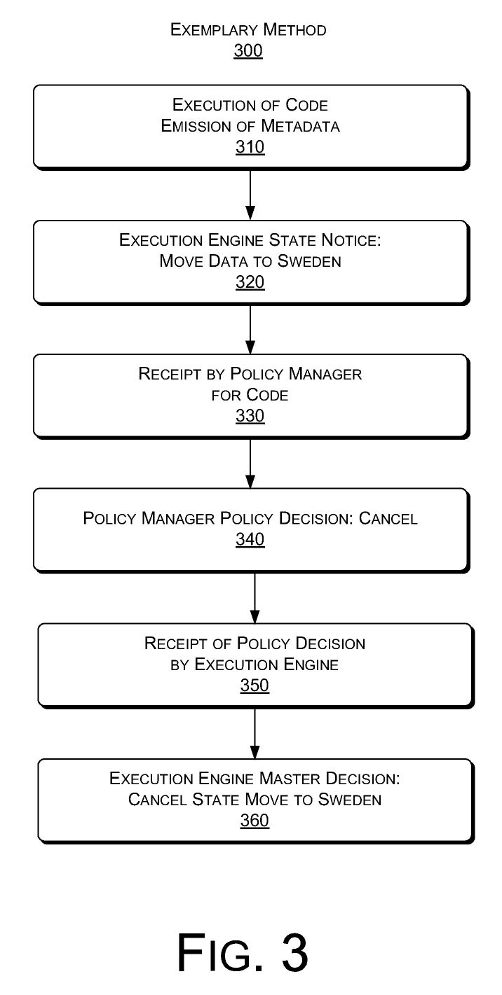

FIG. 3 shows an exemplary method 300 that may be implemented in the environment 200 of FIG. 2. The method 300 commences in an execution block 310 where upon execution of code, metadata is emitted. Such metadata may include an identifier that identifies a service provider, one or more service level agreements, etc. The metadata may include a parameter value that notifies an execution engine that location of data generated upon execution of the code is part of a service level agreement or simply that any change in state of location of the data is an event that must be communicated to an associated policy module.

In another execution block 320, an execution engine, which may be a state machine, emits a notice (e.g., state information) that indicates the data generated upon execution of the code is to be moved to Sweden (e.g., a possible future state). The emission of such a notice may be by default (e.g., communicate all geographical moves) or explicitly in response to an execution engine checking a policy module (e.g., calling a routine, etc.) having a policy that relates to geography. Such a move may be in response to maintenance at a data center where data is currently located or to be stored. According to the method 300, in a reception block 330, a policy manager (e.g., a policy module such as a plug-in) for the code receives the emitted notice. Logic programmed in the policy manager may respond automatically up receipt of the emitted notice. For example, where a policy manager is a plug-in, the emitted notice may be routed from the execution engine to the plug-in. As indicated in a decision block 340, the policy manager responds by emitting a decision to not move the data to Sweden. In another reception block 350, the emitted decision is received by the execution engine. In turn, the execution engine makes a master decision to select an alternative state that does not involve moving the data to Sweden.

As described herein, a policy module may be a plug-in or other type of unit configured with logic to make policy decisions. A plug-in may plug into a policy management layer associated with resources in the cloud and remain idle until relevant information becomes available, for example, in response to request for a service in the cloud. A scheme may require plug-in subscription to a policy management layer. For example, a service provider may subscribe to an overarching system of a cloud manager and as part of this subscription submit code and policy module for making policy decisions relevant to a service provided by the code. In this example, the service provider may login to a cloud service via a webpage and drop off code and policy module or select policy modules from the cloud service or vendors of policy modules. While various components in FIGS. 1 and 2 are shown as being outside of the boundary of the cloud 101 or 201, it is understood that these components may be in the cloud 101 or 201 and implemented by cloud resources.

As described herein, APIs such as the APIs 260 may be configured to expose event and/or state information of an execution engine such as the execution engine 240. While various examples refer to an execution engine “emitting” event and/or state information, APIs are often defined as “exposing” information. In either instance, information becomes accessible or otherwise available to one or more policy decision making entities which may be plug-ins or other types of modules or logic structures.

A policy module can carry one or more logical constraints that can constrain an action or actions to be taken by an execution engine. In a particular example, the policy module includes a constraint solver that can solve an equation based on constraints and information received from an execution engine (directly or indirectly) where a solution to the equation is or is used to make a policy decision. Resources to execute such a constraint solver may be inherent in the policy management layer 270 or APIs 260 in the environment 200 of FIG. 2. In general, a policy module resides in memory and can execute based on resources provided in the cloud or provided by a cloud manager (e.g., which may be secure resources with firewall or other protections from the cloud at large).

In various examples, an execution engine may be defined as a state machine and an action may be defined with respect to a state (e.g., a future state). An execution engine as a state machine may include a state diagram that is available at various levels of abstraction to service providers or others depending on role or need. For example, a service provider may be able to view a simple state diagram and associated event and/or state information that can be emitted by the execution engine for use in making policy decisions (e.g., via a policy management layer). If particular details are not available in the simple state diagram, a service provider may request a more detailed view. Accordingly, a cloud manager may offer various levels of detail and corresponding policy controls for selecting by a service provider that ultimately form a binding service level agreement between the service provider and the cloud manager. In some instances, a service provider may be a tenant of a data center and have an agreement between the data center and other agreements (e.g., implemented via policy mechanisms) related to provision of service to end users (e.g., via execution of code, storage of data, etc.).

As described in more detail below, a policy module may be extensible whereby a service provider or other party may extend its functionality and hence decision making logic (e.g., to account for more factors, etc.). A policy module may include an identifier, a security key, or other feature to provide assurances.

As described herein, an exemplary policy module may make policy decisions as to cost or budget. For example, a policy module may include a number of units of memory, computation, etc., that are decremented through use of a service executed in the cloud. Hence, as the units decrement, the policy module may decide to conserve remaining units by allowing for more latency in computation time, longer access times to data stored in memory, lesser priority in queues, etc. Or, in another example, a policy module may simply cancel all executions or requests once the units have run out. In such a scheme, a service provider may purchase a number of units and simply allow the service to run in the cloud until the number of units is exhausted. Such a scheme allows a service provider to cap costs by merely selecting an appropriate cost-capping policy module that plugs-in or otherwise interacts with a cloud management system (e.g., consider the cloud resource manager 202 and the associated components 240, 250, 260, 270 and 280).

While the example of FIG. 2 shows only a single service provider 204 and a single block of code 230, an environment may exist with multiple related service providers that each provides one or more blocks of code. In such an environment, the service providers may coordinate efforts as to policy. For example, one service provider may be responsible for policy as to execution of a particular block of code and another service provider may be responsible for policy as to execution of another block of code that relies on the particular block. In such an environment, a policy module may include dependencies where event and/or state information for one code are relied on for making decisions as to other, dependent code. Hence, a policy module may issue a decision to change state for execution of code that depends on some other code that is experiencing performance issues. This scheme can allow a service provider to automatically manage its code based on performance issues experienced by code associated with a different service provider (e.g., as expressed in event and/or state information emitted by an execution engine).

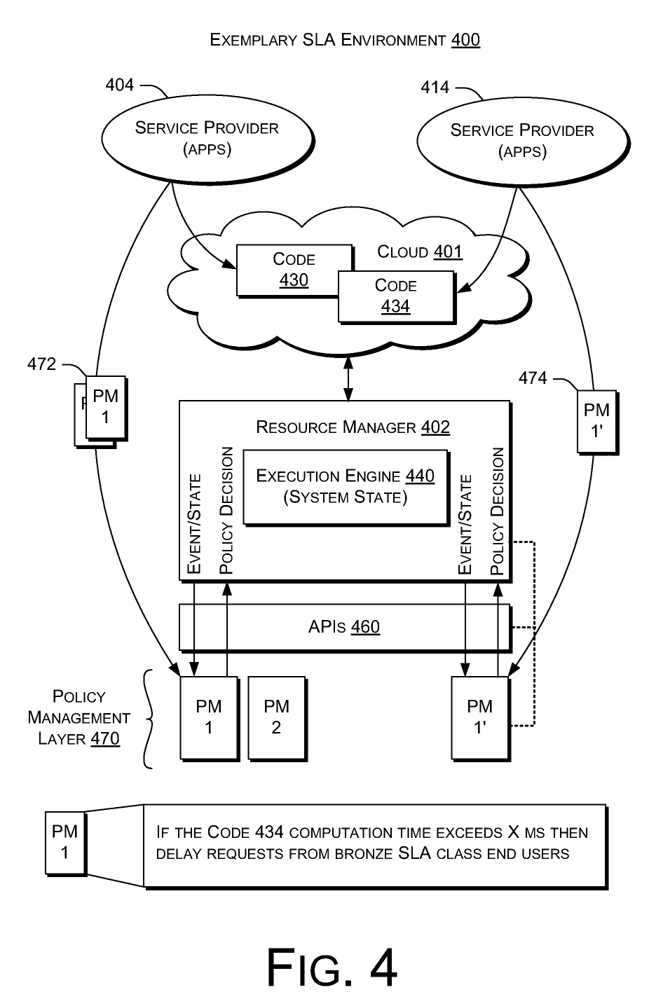

FIG. 4 shows an exemplary environment 400 with two service providers 404, 414 that submit code 430, 434 into the cloud 401. The service provider 404 issues policy information 472 in the form of policy modules PM 1 and PM 2 to a policy management layer 470 and the service provider 414 issues policy information 474 in the form of policy module PM 1′ to the policy management layer 470. As indicated, the policy module PM 1 includes a policy that states: “If the code 434 computation time exceeds X ms then delay requests from bronze SLA class end users”.

In the example of FIG. 4, the policy management layer 470 may be part of or under direct control of the resource manager 402, which may be a data center or a cloud resource manager. In general, the resource manager 402 includes features additional to those of the execution engine 440. For example, the resource manager 402 may include billing features, energy management features, etc. As shown in FIG. 4, the execution engine 440 may be a component of the resource manager 402. In various examples, a resource manager may include multiple execution engines (e.g., on a data center or other basis).

In the example of FIG. 4, the APIs 460 may be part of the resource manager 402 and effectively create the policy management layer 470 in combination with one or more policy modules. In such an example, the policy modules may be code or XML that is consumed via the APIs 460. In another example, the policy modules may be code that is executed on a computing device (e.g., optionally a VM) where, upon execution, calls are made via the APIs 460 and/or information transferred from the APIs 460 to the executing policy module code. In this example, the policy modules may be relatively small applications with an ability to consume information germane to policy decision making and to emit information indicative of whether an action or a state is acceptable for a service hosted by the resource manager 402. For example, emitted information may be received by a fabric controller such as the AZURE® fabric controller to influence (or dictate) states and state selection (e.g., goal state, movement toward goal state, movement toward a new goal state, etc.).

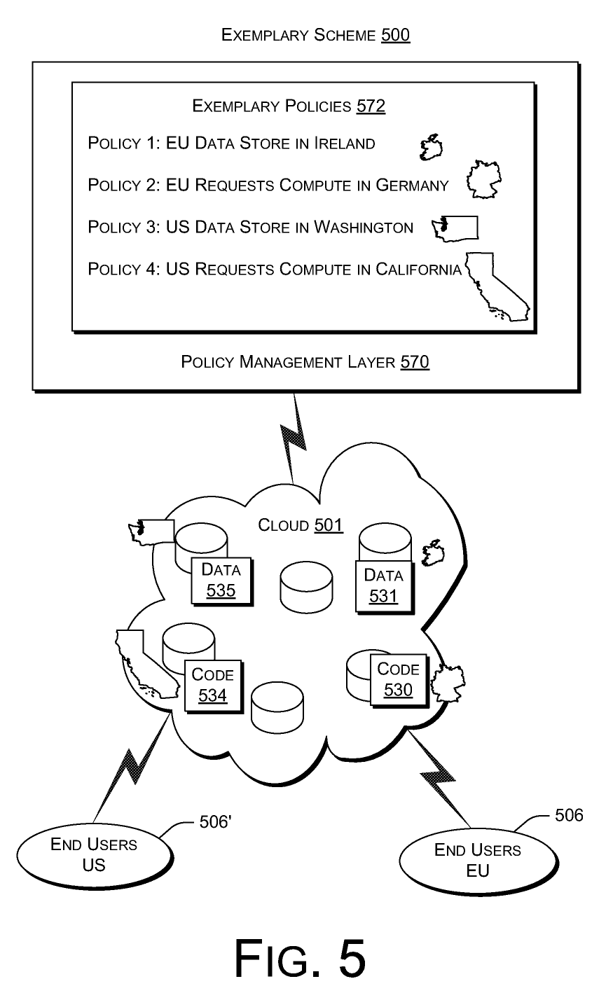

FIG. 5 shows an exemplary scheme 500 where a policy management layer 570 manages resources in a cloud 501 according to various policies 572. In this example, a service provider relies on execution of code 530, 534 and storage of data 531, 535 in the cloud 501. The policies 572 include: 1. EU data store in Ireland; 2. EU requests compute in Germany; 3. US data store in Washington; and 4. US compute in California. These policies require knowledge as to assignment of end users 506, 506′ to the US or the EU. Such policies may be enforced by a metadata generator in the code 530, 534 that upon loading in a data center emits metadata that causes an execution engine to emit location of a request for execution of the code 530, 534 (e.g., request from Belgium to check stock portfolio). Before execution of the code 530, 534, the execution engine emits a location associated with the request such that the policy management layer 570 can enforce its stated policies. The policy management layer 570 may respond by allowing the request to proceed, prohibiting the request to proceed or by routing the request to its proper site (e.g., Germany or California).

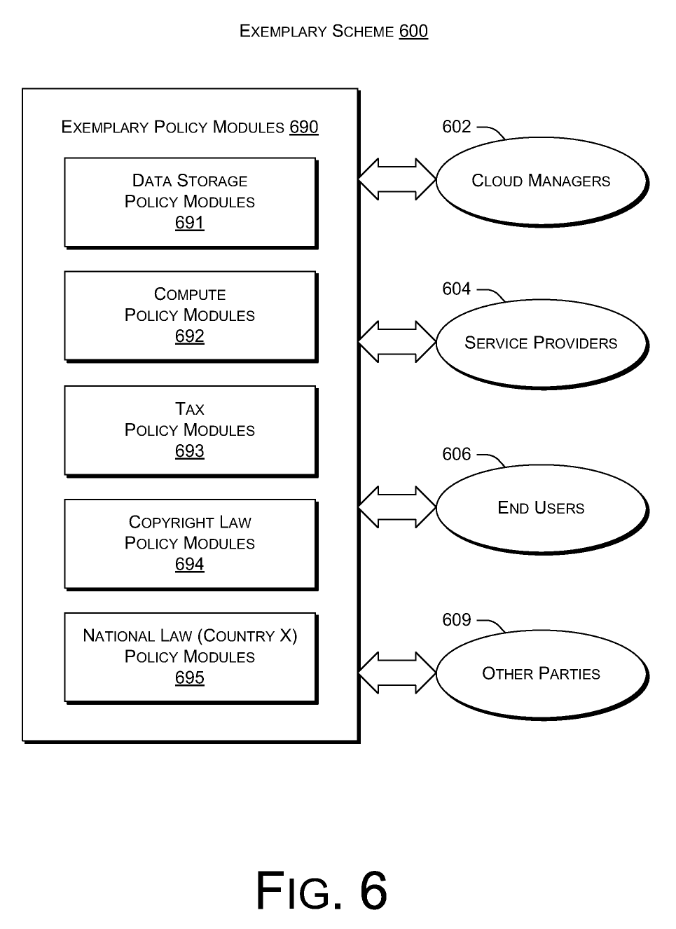

FIG. 6 shows an exemplary scheme 600 that includes various exemplary policy modules 690 and various participants including cloud managers 602, service providers 604, end users 606 and other parties 609. In the example of FIG. 6, the policy modules 690 include data storage policy modules 691, compute policy modules 692, tax policy modules 693, copyright law policy modules 694 and national law policy modules 695; noting that other different policy modules may be included.

The policy modules 690 may be based on information provided by one or more cloud managers 602. For example, one of the cloud managers 602 may publish a list of emitted event and/or state information for one or more data centers or other cloud resources. In turn, service providers 604, end users 606 or other parties 609 may develop or use one or more of the policy modules 690 that can make policy decisions based on the emitted event and/or state information. An exemplary policy module may also include features that allow for interoperability with more than one list of event and/or state information.

With respect to the data storage policy modules 691, these may include policies as to data location, data type, data size, data access latency, data storage cost, data compression/decompression, data security, etc. With respect to the compute policy modules 692, these may include policies as to compute location, compute latency, compute cost, compute consolidation, etc. With respect to the tax policy modules 693, these may include policies as to relevant tax laws related to data storage, compute, data transmission, type of transaction, logging, auditing, etc. With respect to the copyright policy modules 694, these may include policies as to relevant copyright laws related to data storage, compute, data transmission, type of transaction, type of data, owner of data, etc. With respect to the national law policy modules 695, these may include policies as to relevant laws related to data storage, compute, data transmission, type of transaction, etc. A policy module may include policy as to international laws, for example, including international laws as to electronic commerce (e.g., payments, binding contracts, privacy, cryptography, etc.).

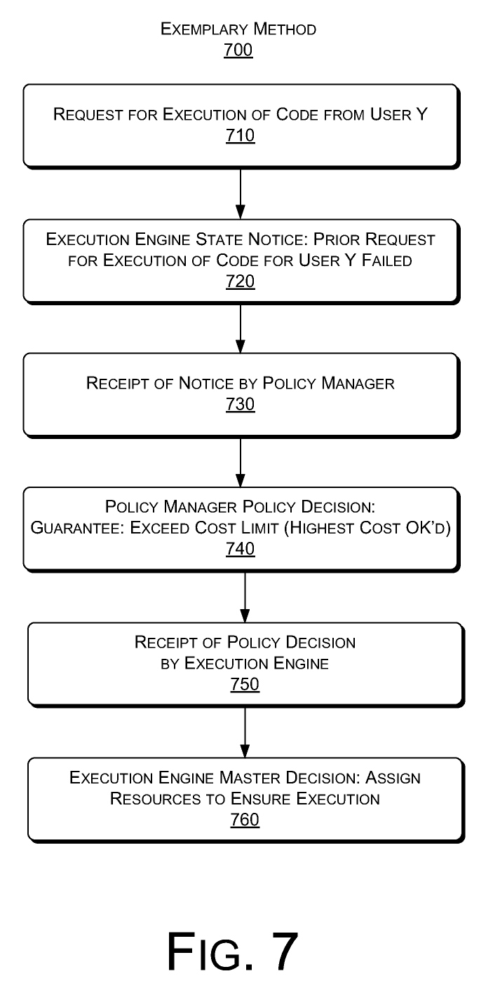

FIG. 7 shows an exemplary method 700 that may be implemented in the environment 200 of FIG. 2. The method 700 commences in a request block 710 where a user (User Y) makes a request for execution of code. In a notification block 720, an execution engine emits a state notice that indicates a failure or degradation in service for User Y in response to a prior request, for example, as related to execution of the code.

In a reception block 730, the notice sent by the execution engine is received by a policy module in a policy management layer. In a decision block 740, the policy module decides that User Y should be guaranteed service to ensure that User Y does not experience a subsequent failure or degradation in service. To effectuate this policy decision, the policy module sends a response to the execution engine to guarantee fulfillment of the request from User Y with permission to exceed a cost limit, which may result in a higher cost to the service provider.

As shown in the example of FIG. 7, the execution engine receives the policy decision. In an assignment block 760, the execution engine assigns resources to the request from User Y to ensure execution. Again, such resources may result in a higher billed cost to the service provider or a reduction in accumulated credit. However, the exemplary method 700 allows the service provider to manage user experience, which can help retain key users.

In the example of FIG. 7, the audit system 250 of the environment 200 may be implemented as a store of information as to failures or degradation in service. For example, as event and/or state information is emitted by the execution engine 240, it may be received by the audit system 250, which can determine whether a prior failure or degradation in service occurred. In turn, the audit system 250 may emit information for consumption by the policy management layer 270 that thereby allows a policy module to respond by making a policy decision based on the emitted event and/or state information and any additional information provided by the audit system 250.

In the foregoing example or an alternative example, the logging layer 280 may queried as to specifics of the failure or degradation in service. As described herein, the logging system 280 may operate in coordination with the execution engine 240, the audit system 250, the APIs 260 and the policy management layer 270. Accordingly, event and/or state information emitted by the execution engine 240 may be supplemented with information from the audit system 250 or the logging layer 280. Further, the cloud resource manager 202 may provide information germane to policy decisions to be made in the policy management layer 270 (e.g., scheduled down time, predicted congestion issues, expected energy shortages, etc.).

As explained herein, various components or mechanisms in the environment 200 may provide a basis for forming a service level agreement, making efforts to abide by a service level agreement and providing remedies for violating a service level agreement. In various examples, a service level agreement between a resource manager and a service provider can be separated from code. In other words, a service provider does not necessarily have to negotiate a service level agreement upon submission of code to a resource manager (or the cloud). Instead, the service provider need only issue policy modules for interaction with a policy management layer to thereby make policy decisions that become a de factor, flexible and extensible “agreement” between the service provider and a manager or owner of resources.

As described herein, an environment may include an exemplary policy management layer to manage policy for a service (e.g., a web-based or so-called cloud-based service). Such a layer can include a policy module for the service where the policy module includes logic to make a policy-based decision and an application programming interface (API) associated with an execution engine associated with resources for providing the web-based service. In such a layer, the API can be configured to communicate information from the execution engine to the policy module and the API can be configured to receive a policy-based decision from the policy module and to communicate the policy-based decision to the execution engine to thereby effectuate policy for the web-based service. While a single policy module and API are mentioned in this example, as explained herein, multiple policy modules may be used, which may have corresponding APIs. Further, the policy management layer of this example may be configured to manage multiple services, which may be independent or related.

As described herein, an execution engine can be or include a state machine that is configured to communicate state information to one or more APIs. In various examples, logic of a policy module can make a policy-based decision based in part on execution engine information communicated by an API to the policy module. An execution engine may be a component of a resource manager or more generally a resource management service. For example, the AZURE® Services Platform includes a fabric controller that manages resources based on state information (e.g., a state machine for each node or virtual machine). Accordingly, one or more APIs may allow policy-based decisions to reach the fabric controller where such one or more APIs may be implemented as part of the fabric controller or more generally as part of the services platform.

As mentioned, a policy-based decision may be communicated to an audit system for auditing performance, for example, of a web-based service as provided by assigned resources. In various examples, a service emits metadata that can instruct an execution engine to emit information for communication to one or more policy modules. Policy modules may include logic for a data location policy, a data security policy, a data retention policy, a data access latency policy, a data replication policy, a compute location policy, a compute security policy, a compute latency policy, a location cost policy, a security cost policy, a retention cost policy, a replication cost policy, a level of service cost policy, a tax cost policy, a bandwidth cost policy, a per instance cost policy, a per request cost policy, etc.

An exemplary policy module optionally includes an accounting mechanism to account for number of policy-based decisions made by the policy module, a security mechanism to enable the policy module to make policy-based decisions or a combination of accounting and security mechanisms.

As described herein, an exemplary method includes receiving a plurality of policy modules where each policy module includes logic for making policy-based decisions; receiving a request for a web-based service; in response to the request, communicating information to at least one of the plurality of policy modules; making a policy-based decision responsive to the communicated information; communicating the policy-based decision to a resource management module that manages resources for the web-based service; and managing the resources for the web-based service based at least in part on the communicated policy-based decision. In such a method, the policy modules may be plug-ins of a policy management layer associated with the resource management module. For example, in the environment 200 of FIG. 2, the policy management layer 270 may be part of or under control of the cloud resource manager 202. In such an example, the policy modules may be considered plug-ins of the cloud resource manager 202 that is implemented at least in part via a resource management module or component (e.g., processor-executable instructions).

In various examples, a resource management module includes an execution engine, which may be or include a state machine that represents resources for a service (e.g., virtual, physical or virtual and physical). In such an example, state information associated with resources for the service may be communicated to one or more policy modules. As mentioned, a policy module may set forth one or more policies (e.g., a policy for location of data associated with a service, a policy for cost of service, etc.).

As described herein, a data policy module for a web-based service may be implemented at least in part by a computing device. Such a policy module can include logic to make a policy-based decision in response to receipt of a location from an execution engine that manages cloud resources for the web-based service where the location indicates a location of data associated with the service and wherein the execution engine manages the cloud resources to effectuate the policy-based decision upon communication of the decision to the execution engine. In such an example, the logic of the policy module may make a policy-based decision that prohibits locating the data in a specified location or may make a policy-based decision that permits locating the data in a specified location. In various examples, a policy module is a plug-in associated with an execution engine for managing resources for a service. In various examples, a policy module communicates with one or more application programming interfaces (APIs) associated with an execution engine for manages resources for a service.

As described herein, a plug-in architecture for policy modules can optionally enable third-party developers to create capabilities that extend the realm of possible policies, support features yet unforeseen and separate source code for a service from policies that may form a service level agreement for the service. With a plug-in architecture, the policy management layer 270 of FIG. 2 may include a so-called “services” interface for plug-ins where a policy module includes a plug-in interface that can be managed by a plug-in manager of the policy management layer 270. In such an arrangement, the policy management layer 270 may be viewed as (or be) a host application for the plug-in policy modules. Often the interface between a host application and plug-ins in a plug-in architecture is referred to as an application programming interface (API). However, other types of APIs exist that do not necessarily rely on plug-ins but rather, for example, an application that is configured to make calls to an API according to a specification, which may specify parameters passed to the API and parameters received from the API (e.g., in response to a call). In various examples, a policy module may not necessarily make an API “call” to receive information, instead, it may be configured or behave more like a plug-in that is managed and receives information as appropriate without need for a “call”. In yet other examples, a policy module may be implemented as an extension.

An exemplary policy management layer specifies or lists types of information that may be communicated via one or more interfaces. In such an example, the interfaces may be APIs (e.g., APIs 260 of FIG. 2) or other types of interfaces. Such an exemplary architecture or framework can allow developers to develop policy modules for any of a variety of policies germane to a service that depends on some resources whether in a datacenter or more generally in the cloud.

FIG. 8 shows an exemplary scheme 800 that includes a service level agreement (SLA) test fabric module 840 that operates to generate a selection of SLA options 882 for code 830 submitted, for example, by a service provider 804. In the example of FIG. 8, the SLA test fabric module 840 includes an execution engine 850, resources 860 for management by the execution engine 850, test cases 870 that include information to test received code and an SLA generator 880 to generate SLAs (e.g., the SLAs 882).

As described in the example of FIG. 8, the SLA test fabric module 840 acts to understand better the code 830 in relationship to resources (e.g., resources in the cloud 801) and its use (e.g., by known or prospective end users 806). Depending on the nature of the code 830 and its supported service to be offered by the service provider 804, types of resources and types of test cases may be specified by the service provider 804. For example, the service provider 804 may submit a list of resources and one or more test cases. In turn, the SLA test fabric module 840 consumes the list of resources and acquires or simulates resources and runs the one or more test cases on the acquired or simulated resources.

With respect to resource acquisition or simulation, the SLA test fabric module 840 may rely on resources in the cloud 801 or it may have its own dedicated “test” resources (e.g., consider the resources 860). Resource simulation by the SLA test fabric module 840 may rely on one or more virtual resources (e.g., virtual machine, virtual memory device, virtual network device, virtual bandwidth, etc.) and may be controlled by the execution engine 850 to execute code (e.g., according to one or more of the test cases 870). In such an exemplary scheme, various resources may be examined and SLA generated by the SLA generator 880 that may match various resource configurations to particular SLA options. For example, the module 840 may test the code 830 on several “real” machines (e.g., server blades, each with an associated operating system) and on several virtual machines that execute on a real machine. Performance metrics acquired during execution of the code 830 may be input to the SLA generator 880, which, in turn, generates an SLA for execution of the code 830 on virtual machines and another, different SLA for execution of the code 830 on a real machine. Further, the SLA generator 880 may specify associated cost or credit for meeting performance levels in each of the SLAs.

With respect to the test cases 870, the SLA test fabric module 840 may be configured to run end user test cases, general performance test cases or a combination of both. For example, end user test cases may be submitted by the service provider 804 that provide data and flow instructions as to how an end user would rely on a service supported by the code 830. In another example, the SLA test fabric module 840 may have a database of performance test cases that repeatedly compile the code 830, enter arbitrary data into the code during execution, replicate the code 830, execute the code 830 on real machines and virtual machines, etc. Such performance test cases may be largely code agnostic, i.e., suitable for most types of code submitted to the SLA test fabric module 840, and aligned with types of SLA provisions for use in generating SLA options. For example, a compile latency metric for the code 830 may be aligned with an SLA provision that accounts for compile latency (i.e., for the given compile latency, if you need to compile more than X times per day, uptime/availability guarantee for the code is only 99.95%; whereas, if you need to compile less than X times per day, uptime/availability guarantee for the code is 99.99%).

Referring again to the scheme 800 of FIG. 8, a timeline 803 is shown along with a series of events: Events A through G. Event A corresponds to the service provider 804 submitting the code 830 to the SLA test fabric module 840. Event B corresponds to the SLA generator 880 of the module 840 outputting multiple SLAs 882. Event C corresponds to the service provider 804 selecting one of the SLAs 882. Event D corresponds to the service provider 804 submitting the code 830 and the selected SLA 882-2 to a cloud manager 802 that manages at least some resources in the cloud 801. Event E corresponds to interactions between the cloud manager 802 and the resources in the cloud 801 to ensure the code 830 is setup for execution to provide a service to the end user 806. Event F corresponds to the service provider 804 entering into a SLA (SP-EU) 820 with the end users 806. Event G corresponds to the end users 806 using the service that relies on the code 830 where the service is provided according to the terms of the SLA SP-EU 820.

Given the scheme 800, if the service provider 804 receives feedback from one or more of the end users 806 as to issues with the service (or opportunities for the service) or receives feedback from the cloud manager 802 (e.g., as to new resources or new management protocols), the service provider 804 may resubmit the code 830, optionally revised, to the SLA test fabric module 840 to determine if one or more different, more advantageous SLAs are available. This is referred to herein as a SLA cycle, which is shown as a cycle between Events A, B and C, with optional input from the cloud manager 802, the cloud 801, the end users 806 or other source. Accordingly, the scheme 800 can accommodate feedback to continuously revise or improve an SLA between, for example, the service provider 804 and the cloud manager 802 (or other resource manager). In turn, the service provider 804 may revise the SLA SP-EU 820 (e.g., to add-value, increase profit, etc.).

In the example of FIG. 8, once the code 830 has been setup and run in the cloud 801 by the end users 806, actual resource data and/or actual “test” cases may be directed from the cloud 801 to the SLA test fabric module 840, to the cloud manager 802, or to the service provider 804. Such a feedback mechanism may operate automatically, for example, upon the service provider 804 contracting with an operator of the SLA test fabric module 840. In another arrangement, the SLA test fabric module 840 may be managed by the cloud manager 802; noting that an arrangement with a third-party operator may be preferred to provide assurances as to objectivity of the SLAs such that they are not biased in favor of the service provider 804 or the cloud manager 802.

Another feature of the SLA test fabric module 840 may check code for compliance with SLA provisions. For example, certain code operations may be prohibited by particular cloud managers (e.g., a datacenter may forbid storage communication of data to a foreign country, may forbid execution of code with unlimited self-replication mechanisms, etc.). In such an example, the SLA test fabric module 840 may return messages to a service provider that point specifically to “contractual” types of “errors” in the code (i.e., code behavior that would pose a significant contractual risk to a datacenter operator and thus prevent the datacenter operator from agreeing to one or more SLA provisions). Such messages may include recommended code revisions or fixes that would make the code comply with one or more SLA provisions. For example, the module 840 may emit a notice that proposed code modifications would break an existing SLA and indicate how a developer could change the code to maintain compliance with the existing SLA. Alternatively, the module 840 may inform a service provider that a new SLA is required and/or request approval from an operations manager to allow the old SLA to remain in place, possibly with one or more exceptions.

The scheme 800 of FIG. 8 can rely on rich data from the cloud 801 and continually build new SLA provisions or piece together existing SLA provisions in manners beneficial to a service provider or a resource manager that manages resources in the cloud 801. For example, the module 840 may be configured to profile aspects of the cloud 801 for specific services or more generally as to traffic, data storage resources, data compute resources, usage patterns, etc.

As described herein, the SLA test fabric module 840 may be implemented at least in part by a computing device and include an input to receive code to support a web-based service; logic to test the code on resources and output test metrics; an SLA generator to automatically generate multiple SLAs, based at least in part on the test metrics; and an output to output the multiple SLAs to a provider of the web-based service where a selection of one of the SLAs forms an agreement between the provider and a manager of resources.

FIG. 9 shows an exemplary method 900 that can form a binding agreement between two or more parties (e.g., a service level agreement). The method 900 commences in a reception block 910 where code is received. A test block 920 tests the code, for example, with respect to resources and/or test cases. An output block 930 outputs test metrics for the test or tests of the code. A generation block 940 generates multiple SLAs based at least in part on the test metrics. An output block 950 outputs the SLAs or otherwise makes them available to one or more parties. In a selection block 960, the method 900 acts to receive a selection of an SLA from one or more parties to thereby form a binding agreement between two or more parties.

As described herein, the module 840 of FIG. 8 may be configured to perform the method 900 of FIG. 9. For example, the module 840 may be executed on a computing device where code may be received (e.g., via a secure network connection). In turn, the computing device may execute the module 840 to test the code and output test metrics (e.g., to memory). After or during testing of the code, logic may generate SLAs based at least in part on the test metrics. In this example, the logic may rely on other factors such as cost constraints, location constraints, etc., which may be received via an input of the computing device, optionally along with the code. The computing device may be configured to output the SLAs or otherwise make them available to one or more parties (e.g., via a web-interface). To expedite launching of services in the cloud, a binding agreement may be formed upon selection of one of the SLAs. Such a process can expedite launching of services as various provisions that make up any particular SLA may be pre-approved by a resource manager. This approach allows for SLAs tailored to code, which is in contrast to a “boilerplate” SLA where “one size fits all” to minimize costs (e.g., legal costs). Further, this approach can allow for resubmission of code depending on changes in code or circumstances whereby a new SLA may be selected that may allow a service provider to pass along saving or performance to end users (e.g., in a dynamic, flexible and/or extensible manner).

As described herein, a SLA test fabric module (e.g., consider the module 840 of FIG. 8) may generate policy modules. For example, the SLAs 882 in the scheme 800 of FIG. 8 may be policy modules suitable for selection and use as plug-ins in the exemplary environment 200 of FIG. 2. Referring to FIG. 6, the SLA test fabric module 840 of FIG. 8 may operate to generate one or more of the exemplary policy modules 690. In such an example, code is provided to the module 840 and exemplary policy modules output, which may underlie a service level agreement between a service provider and a resource manager. Depending on the arrangement of parties, the service provider 804 may download selected policy modules output by the SLA test fabric module 840 and submit those to a policy management layer (e.g., consider the policy management layer 270 of FIG. 2). Alternatively, upon selection of a policy module, the module may be automatically instantiated or otherwise plugged-in to a policy management layer for managing policy for code that supports a service.

### Exemplary Computing Environment

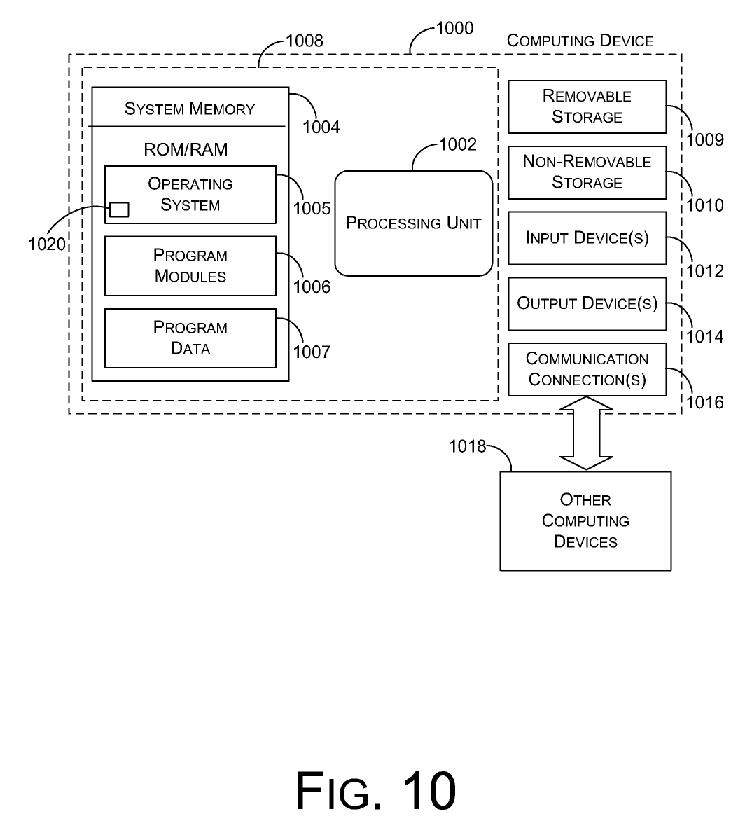

FIG. 10 illustrates an exemplary computing device 1000 that may be used to implement various exemplary components and in forming an exemplary system or environment. For example, the environment 100 of FIG. 1, the environment 200 of FIG. 2 or the scheme 800 of FIG. 8 may include or rely on various computing devices having features of the device 1000 of FIG. 10.

In a very basic configuration, computing device 1000 typically includes at least one processing unit 1002 and system memory 1004. Depending on the exact configuration and type of computing device, system memory 1004 may be volatile (such as RAM), non-volatile (such as ROM, flash memory, etc.) or some combination of the two. System memory 1004 typically includes an operating system 1005, one or more program modules 1006, and may include program data 1007. The operating system 1005 include a component-based framework 1020 that supports components (including properties and events), objects, inheritance, polymorphism, reflection, and provides an object-oriented component-based application programming interface (API), such as that of the .NET™ Framework manufactured by Microsoft Corporation, Redmond, Wash. The device 1000 is of a very basic configuration demarcated by a dashed line 1008. Again, a terminal may have fewer components but will interact with a computing device that may have such a basic configuration.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by removable storage 1009 and non-removable storage 1010. Computer storage media may include volatile and nonvolatile, removable and non-removable media implemented in any method or technology for storage of information, such as computer readable instructions, data structures, program modules, or other data. System memory 1004, removable storage 1009 and non-removable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of device 1000. Computing device 1000 may also have input device(s) 1012 such as keyboard, mouse, pen, voice input device, touch input device, etc. Output device(s) 1014 such as a display, speakers, printer, etc. may also be included. These devices are well know in the art and need not be discussed at length here.

Computing device 1000 may also contain communication connections 1016 that allow the device to communicate with other computing devices 1018, such as over a network. Communication connections 1016 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A policy management layer to manage policy for a web-based service, implemented at least in part by a computing device, the policy management layer comprising:
a policy module for the web-based service wherein the policy module comprises logic to make a policy-based decision; and
an application programming interface (API) associated with an execution engine associated with resources for providing the web-based service,
wherein the API is configured to communicate information from the execution engine to the policy module, and
wherein the API is configured to receive a policy-based decision from the policy module and to communicate the policy-based decision to the execution engine to thereby effectuate policy for the web-based service.

2. The policy management layer of claim 1 wherein the execution engine comprises a state machine configured to communicate state information to the API.

3. The policy management layer of claim 1 wherein the logic to make a policy-based decision makes a policy-based decision based in part on execution engine information communicated by the API to the policy module.

4. The policy management layer of claim 1 wherein a policy-based decision is communicated to an audit system for auditing performance of the web-based service by the resources.

5. The policy management layer of claim 1 wherein the web-based service emits metadata that instructs the execution engine to emit information for communication to the policy module.

6. The policy management layer of claim 1 wherein the policy module comprises a data policy that comprises at least one data policy selected from a group consisting of a data location policy, a data security policy, a data privacy policy, a data retention policy, a data access latency policy and a data replication policy.

7. The policy management layer of claim 1 wherein the policy module comprises a compute policy that comprises at least one compute policy selected from a group consisting of a compute location policy, a compute security policy, and a compute latency policy, a compute throughput policy, and a compute privacy policy.

8. The policy management layer of claim 1 wherein the policy module comprises a cost policy that comprises at least one cost policy selected from a group consisting of a location cost policy, a security cost policy, a retention cost policy, a replication cost policy, a level of service cost policy, a tax cost policy, a bandwidth cost policy, a per instance cost policy, and a per request cost policy.

9. The policy management layer of claim 1 where the policy module comprises a policy module selected from a plurality of policy modules wherein the selected policy module comprises an accounting mechanism to account for number of policy-based decisions made by the policy module.

10. The policy management layer of claim 1 where the policy module comprises a policy module selected from a plurality of policy modules wherein the selected policy module comprises a security mechanism to enable the policy module to make policy-based decisions.

11. A method comprising:
receiving a plurality of policy modules wherein each policy module comprises logic for making policy-based decisions;
receiving a request for a web-based service;
in response to the request, communicating information to at least one of the plurality of policy modules;
making a policy-based decision responsive to the communicated information;
communicating the policy-based decision to a resource management module that manages resources for the web-based service; and
managing the resources for the web-based service based at least in part on the communicated policy-based decision.

12. The method of claim 11 wherein the policy modules comprises plug-ins of a policy management layer associated with the resource management module.

13. The method of claim 11 wherein the resource management module comprises an execution engine that comprises a state machine that represents resources for the web-based service.

14. The method of claim 11 wherein the communicated information comprises state information associated with the resources for the web-based service.

15. The method of claim 11 wherein the policy modules comprise a policy for location of data associated with the web-based service.

16. The method of claim 11 wherein the policy modules comprise a policy for cost of the web-based service.

17. A data policy module for a web-based service, implemented at least in part by a computing device, the data policy module comprising:
logic to make a policy-based decision in response to receipt of a location from an execution engine that manages cloud resources for the web-based service wherein the location indicates a location of data associated with the service and wherein the execution engine manages the cloud resources to effectuate the policy-based decision upon communication of the decision to the execution engine.

18. The data policy module of claim 17 wherein the logic comprises logic to make a policy-based decision that prohibits locating the data in a specified location.

19. The data policy module of claim 17 wherein the logic comprises logic to make a policy-based decision that permits locating the data in a specified location.

20. The data policy module of claim 17 wherein the policy module comprises a plug-in associated with the execution engine.

21. The data policy module of claim 17 wherein the policy module communicates with one or more application programming interfaces (APIs) associated with the execution engine.

22. A service level agreement (SLA) test fabric module, implemented at least in part by a computing device, the SLA test fabric module comprising:
an input to receive code to support a web-based service;
logic to test the code on resources and output test metrics;
an SLA generator to automatically generate multiple SLAs, based at least in part on the test metrics; and
an output to output the multiple SLAs to a provider of the web-based service wherein a selection of one of the SLAs forms an agreement between the provider and a manager of resources.

23. The SLA test fabric module of claim 22 wherein the input is configured to receive specified resources.

24. The SLA test fabric module of claim 22 wherein the input is configured to receive specified test cases.

25. The SLA test fabric module of claim 22 wherein the input is configured to receive specified cost constraints.

26. The SLA test fabric module of claim 22 wherein the multiple SLA comprise SLAs pre-approved by a resource manager.
